(19) United States
(12) Patent Application Publication
(10) Pub. No.: US 2012/0323702 A1
(43) Pub. Date: Dec. 20, 2012

(54) SYSTEM AND METHOD FOR CLIENT-SERVER COOPERATION IN SELECTING CONTENT FOR DISPLAY

(76) Inventors: Emmanuel Puentes, Erie, CO (US); Douglas Alan Farmer, Castle Rock, CO (US); Daniel Mark Jones, Niwot, CO (US)

(21) Appl. No.: 13/524,851

(22) Filed: Jun. 15, 2012

Related U.S. Application Data
(60) Provisional application No. 61/497,859, filed on Jun. 16, 2011.

(51) Int. Cl. G06Q 30/02; G06F 15/16

(52) U.S. Cl. 705/14.71; 709/203

(57) ABSTRACT

A system and method is disclosed for selecting content for display in an electronic document. In one embodiment, a first machine generates instructions tailored for execution on a second machine and transmits the instructions to the second machine over a network. The generated instructions cause the second machine to select, for display in the electronic document, a particular content item from a list of potential content items specified in the instructions.

### PRIORITY

The present application claims priority from commonly owned and assigned U.S. Provisional Application No. 61/497,859, Attorney Docket No. OUTF-004/00US 307246-2009, entitled “System and Method For Client-Server Cooperation in Selecting Content for Display,” which is incorporated herein by reference in its entirety and for all purposes.

### FIELD OF THE INVENTION

The present invention relates generally to automated techniques for the selection of media content. In particular, but not by way of limitation, the present invention relates to the generation of instructions that cause a machine to select an item for display from a collection of potential content sources.

### BACKGROUND OF THE INVENTION

Computing machinery, storage systems, and data communication networks are frequently employed in the storage and retrieval of documents. As technology has evolved, the storage and retrieval of documents has similarly grown more sophisticated.

One application of document storage and retrieval is the creation of webs of documents, where documents are interlinked by references, sometimes called links or hyperlinks. For example, one well-known web is the World Wide Web which is a document web based on the Internet.

It is often the case in a web that a client machine requests content from a server machine. The request is often part of a client process of generating a display, and the request is for content to be displayed in a page or part of a page on the client computer.

Those familiar with the art will appreciate that the server can respond to the client request in a variety of ways. For example, the server can return an image or text to be displayed. The server can also return a source document comprising markup language to instruct the client in the generation of a display. In addition, the server can respond with a set of instructions that the client can execute to produce the display. The instructions can take many forms and are frequently coded in a programming language.

It is sometimes desired to show content on a web display in such a way that the content itself is not predetermined, but the type and characteristics of the content are predetermined. For example, it is often desired to display an advertisement on a web page. The exact advertising content is not predetermined but is requested from a server contemporaneously with the generation and display of other content on the same page.

A key challenge in selecting content at display time is that the content to be displayed must be selected, retrieved, and rendered nearly simultaneously with the other content on the page so that the viewer sees the content of all regions almost simultaneously.

However, it is also often advantageous to employ sophisticated logic in selection of content. In the case of advertising, selection of content is often directly related to production of revenue and satisfaction of user and advertiser needs.

In conventional systems, much of the logic of ad selection is performed through interactions with a server. This has several drawbacks and results in several limitations. The server resources can be taxed, resulting in a limitation on the number of clients a server can provide with a timely response. If the server response time is slow, users can experience annoying delays. A further disadvantage to performing ad selection logic involving many interactions with a server is that limited server resources necessitate implementation of selection processes and algorithms that are not optimal but that can be executed rapidly to reduce load on the server.

It is thus apparent that there is a need in the art for an improved system and method for selecting content to display in a region of a displayed web page.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for selecting content for display in an electronic document. In one embodiment, a first machine generates instructions tailored for execution on a second machine and transmits the instructions to the second machine over a network. The generated instructions cause the second machine to select, for display in the electronic document, a particular content item from a list of potential content items specified in the instructions.

This and other embodiments are described in greater detail below.

### BRIEF DESCRIPTION OF THE DRAWINGS

Various objects and advantages and a more complete understanding of the present invention are apparent and more readily appreciated by reference to the following Detailed Description when taken in conjunction with the accompanying Drawings, wherein:

FIG. 1A is a schematic depiction of an exemplary environment in which various illustrative embodiments of the invention can be practiced;

FIG. 1B is a functional block diagram of a machine equipped with a web server application in accordance with an illustrative embodiment of the invention;

FIG. 1C is a functional block diagram of a machine equipped with a client application in accordance with an illustrative embodiment of the invention;

FIGS. 2A, 2B and 2C illustrate the technique of code generation used in illustrative embodiments of the invention;

FIG. 3A is a schematic depiction of components and connections which can be used to illustrate various embodiments of the invention;

FIG. 3B depicts components interacting in accordance with the prior art;

FIG. 3C depicts components interacting in accordance with an illustrative embodiment of the invention;

FIG. 3D depicts components interacting in accordance with another illustrative embodiment of the invention;

FIG. 4A illustrates a client instruction structure according to an illustrative embodiment of the invention;

FIG. 4B illustrates components of a client instruction structure according to an illustrative embodiment of the invention;

FIGS. 4C and 4D are flow charts depicting processes associated with illustrative embodiments of the invention.

FIG. 5 is a flow chart illustrating a process for generating client instructions in accordance with illustrative embodiments of the invention; and

FIG. 6 schematically depicts a displayed page in accordance with an illustrative embodiment of the invention.

### DETAILED DESCRIPTION

In the descriptions and drawings that follow, a small number of components and connections are sometimes described or depicted to facilitate explanation and illustration. The number of components depicted herein is merely illustrative. It should be understood that these examples do not limit the ultimate capability of the invention, including quantity of components, or the number of instances or interconnections that are possible. The embodiments disclosed below are not intended to be exhaustive or limit the invention to the precise form disclosed in the following detailed description. Rather, the embodiments are chosen and described so that others skilled in the art may utilize its teachings.

The detailed descriptions that follow include algorithms and symbolic representations of operations on data within a computer memory, wherein the data is stored and retrieved by means of manipulation of physical qualities such as electrical or magnetic properties of materials. The computer data often correspond to abstract human conceptual items such as documents, files, records, and data. Conceptual items are represented in a computer memory by use of various encoding schemes. These descriptions and representations are an abstraction used by those skilled in the data processing arts to most effectively communicate aspects of their work to others skilled in the art.

An algorithm is conventionally understood to be a predefined sequence of processes and decisions leading to a desired outcome. Executing these processes and producing the outcome is a consequence of manipulation of physical entities. Usually, though not necessarily, these entities are expressed as electrical or magnetic signals and states that are stored, transferred, combined, compared, or otherwise manipulated. It is convenient at times to refer to these states and signals at a higher level of abstractions, using terms such as bits, values, symbols, characters, display data, terms, numbers, or the like. It should be borne in mind, however, that all of these and similar terms are associated with the corresponding physical quantities and the abstractions used herein map to these quantities.

Terms commonly associated with mental or physical operations performed by a human operator are often employed to explain the manipulations performed by computing machinery. Examples of such terms include adding, multiplying, fetching, storing, reading, writing, or deciding. However, the use of these terms is descriptive only and does not imply that a human operator is necessary or desirable. In fact, a human operator is undesirable in most cases, and the operations described which form part of the embodiments and descriptions herein are machine operations. Useful machines for performing such operations include general-purpose digital computers, special-purpose computers, or other similar devices.

In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general-purpose computer as selectively activated or configured by a computer program stored in the computer. The apparatus may also comprise a “cluster,” wherein multiple computers with an interconnecting data network are configured to act in concert for the intended purpose.

It should be appreciated that the methods and operations described herein comprise multiple complex functions that interact with one another and outside entities. The operation or function of these methods is usually not immediately apparent from a software listing. Nor is it easy to determine how a program works through observation of the readily apparent manifestations or artifacts of its operation. Most of the operations carried out by a computer in response to a program are not visible to an observer since only a relatively few of the operations in execution of a program typically produce observable output.

The term “windows” and associated terms such as “windowing environment” or “running in windows” refer to a type of computer user interface, exemplified by the several windowing systems available from Microsoft Corporation of Redmond, Wash. Other windows computer interfaces are available, for example from Apple Computer, Inc. of Cupertino, Calif. and as components of the LINUX operating environment. In particular, it should be understood that the use of these terms in the descriptions herein does not imply a limitation to any particular computing environment or operating system.

The term “real-time” (also “realtime”) or “near real-time” means a system design approach that uses timing as a primary design objective. In particular, a real-time system completes one or more operations within a time interval that meets predetermined criteria. The term can also be used to refer to an operation performed, for example an “update in real-time.” The time interval criteria may be a specific amount of time, or may be defined in contrast to another non-real-time system, sometimes referred to as “batch” or “offline” system. It can be appreciated that the time interval is determined by requirements that vary among systems. For example, a high-performance aircraft real-time control system may be required to respond in microseconds, while for a real-time reservoir level regulator update intervals of hours may be acceptable. In interactions with a human user, a system providing “real-time response” means a user receives a response to an input quickly enough to allow interactive or “live” use of the system without an unacceptable delay (typically, a user might accept a delay of less than a second for transactions that are expected to be immediate, while a user might accept a delay of a minute for a complicated transaction requiring interaction with a remote site).

Several terms have special meanings in the descriptions that follow. The terms “document,” “page,” web page,” “online document,” or “electronic document” all refer to an electronic form of a published work, where such work may be the product of a human author or generated by a machine or other automated process. These documents are stored and manipulated in digital form, that is as a series of encoded media and data structures that are able to be stored and transmitted in forms compatible with digital computers and computer networks.

As used herein, the term “image” refers to a media element included in a document that communicates to a viewer primarily by visual impression rather than by reading. Examples of an image, without limitation, include a color photograph, a black and white photograph, a half-tone picture, a line drawing, a chart, a table, a sketch, a presentation slide, a data graph, and tabular data. An image is sometimes composed partially or entirely of text, words, or characters. An image can be still or moving. A “moving image” is an ordered sequence of still images. A moving image is sometimes called an “animation” or “movie.”

As used herein, the term “web” refers to an interlinked set of documents and the interconnections, protocols, software applications, and machinery that operates to make those documents available within the web. Some of the documents in a web contain links referring to other documents in the web. Documents on a web are typically viewed using a “web browser” that interacts with a user by retrieving web documents, rendering those documents, and following links. The links from one web document to another web document or from one location in a web document to another location in that same web document are also referred to as “web links” or “hyperlinks.” Applications or machinery that respond to requests for web documents are known as “web servers.”

One instance of a web known to those skilled in the art is referred to as the “World Wide Web,” which uses the Internet as a substratum. The descriptions herein can apply to the World Wide Web. However, it should be understood that the principles of the instant invention apply to webs in general and are not limited to the World Wide Web nor to any particular instance of a web. Neither are the principles of the invention limited to webs based on any particular network or collection of networks. For example, an organization may have a document web available on a local intranet or a private network.

It is important in dealing with electronic documents to distinguish between the “source document” and the “display document.” A source document typically contains information for producing a display document, where the display document is what a user sees on a computer screen or in a hardcopy printed form of the document. The display document is analogous to printed material in that it is designed to be viewed by a user. By contrast, the source document corresponding to a display document provides information on how to generate the display document. It may contain for example, display formatting directives, markup, annotation, media content, links to external media content, and metadata providing information about the document. An important consideration is that a source document does not necessarily contain all the media content that will be displayed when the document is rendered. Instead, the source document can include links or hyperlinks that describe where the content can be found and retrieved when the document is rendered.

In some instances a source document includes executable software, often termed “code.” For example, many browsers are capable of executing functions provided in the JAVA or JAVASCRIPT languages as software code. JAVA is a programming language and environment available under license from Sun Microsystems of Santa Clara, Calif. JAVASCRIPT is a scripting language based on the ECMAscript standard. Although the two languages have similar names, they are distinct and differ in many aspects of features and utility. There are other languages available that operate to provide functionality in a browser or rendering process. These languages allow logic and processing directions to be specified that are executed in a client application such as a browser at the time the document is rendered. Those skilled in the art will appreciate the benefits and results that can be achieved by including executable code in a source document.

Conversion from the source document to the display document is a process usually termed “rendering.” The rendering operation is a primary function of browsers and associated media decoders. Rendering may include decoding media, fetching data references from links in the source document, formatting, applying style rules, and other processes to fetch, decode and display elements called for or included in the source document. Rendering may also include execution of software code that is included in the source document.

Many formats for source documents have been defined as formal or de facto standards. Some exemplary formats are The International Standards Organization (ISO) Standardized Generalized Markup Language (SGML), Hyper-Text Markup Language (HTML), Extensible Markup Language (XML), and Rich Text Format (RTF). The Microsoft Corporation of Redmond Wash. has defined a number of source document formats for use with computer applications marketed by the company. The Microsoft formats are widely used and include file storage and sharing formats for the company's WORD, EXCEL, VISIO, and POWERPOINT products. The source document formats listed herein are by way of example only and should not be taken as limiting or complete. The features and descriptions herein are in no way dependent on use of any specific source document type or format. Rather, the features and descriptions herein are applicable to any source document format, whether the format exists at present or is created in the future.

A source document can include one or more media elements. A media element may be part of the source document, in which case the media content is encoded and included as part of the source document material. A media element may also be included in a source document by reference, in which case the source document contains a link, address, location, or pointer that describes the linked media content specifically enough to allow a renderer to obtain the content. Such links can include information about the linked content. For example, an image link may include information about the dimensions of the image. A common way to include a link is defined in the HTML source document format, where the link comprises a Uniform Resource Identifier (URI), Uniform Resource Locator (URL), or Uniform Resource Name (URN).

It should be appreciated that the features and descriptions herein are not limited to any specific media format or encoding scheme, nor are they limited to a set of formats or encoding schemes. By way of example, some media encoding schemes representative of those compatible with the features and descriptions herein are listed. For an image or picture media, exemplary encoding schemes include Tagged Image File Format (TIFF), Joint Photographic Experts Group (JPEG), Apple Computer PICT format, Graphics Interchange Format (GIF), Portable Network Graphics (PNG).

Those familiar with the art will appreciate that there are many encoding schemes employed with various attributes such as vector or bitmapped graphics representation, compression, or inclusion of other data or metadata.

Similarly video or motion pictures can be encoded and decoded by a number of schemes. Exemplary schemes include those defined by the publications of the Moving Picture Experts Group of the ISO (MPEG), Apple Computer Corporation's QUICKTIME media format, Microsoft Corporation's WINDOWS MEDIA Player (WMP), or the REALAUDIO, REALVIDEO, and REALMEDIA formats from RealNetworks, Inc. of Seattle Wash. These formats can include other media types such as synchronized audio or presentation slides. Audio media content may be encoded by a number of schemes. Another notable source document and media format is the Portable Document Format (PDF) from Adobe Systems of San Jose, Calif.

Text is often encoded using the standard American Standard Code for Information Interchange (ASCII or US-ASCII), which defines a numerical representation of common characters found in English and other languages based on a Latin alphabet. Another frequently used representation is Unicode which defines encoding for characters used in many written languages. Further encoding of text media content can include information on font, character size, spacing, line breaks, and other details of displaying text on a page. It should be appreciated that the features and descriptions herein are in no way limited to any specific language or text encoding scheme.

It should also be appreciated that the features and descriptions herein can be used with other media types and rendering apparatuses, whether presently known or conceived in the future. For example, an encoding scheme for aroma, touch, or stimulation of other human senses is consistent with the principles of the invention.

In the descriptions and drawings that follow, frequent reference is made to advertising content, often abbreviated as “advertising,” an “ad,” or “ads.” For purposes of these descriptions, ads refer to media or content displayed to a user in connection with the promotion of goods, services, events, or a combination thereof. An ad can also refer to source documents that produce the content displayed. For each advertisement, a sponsor or advertiser pays for the ad to be displayed, often desiring that the ad be seen by users matching various criteria. Viewers of ads are sometimes referred to as “audience.” Viewers desired by an ad's sponsor are a “target audience.” Ads displayed are also sometimes referred to as “banners.” Ads or banners can comprise, without limitation, images, text, multiple images, moving images, audio, video, or combinations of any media types.

A collection of related advertising content is sometimes referred to as a campaign. For example, a campaign comprises one or more ads for a product or related products. An advertiser often sets goals for a campaign rather than, or in addition to, goals for individual ads. For example, an advertiser often desires a target audience for a campaign. Often a campaign includes multiple ads with different properties so that the ads can satisfy a variety of requests. For example, a campaign my include ads in several sizes so that at least one ad will satisfy a request for an ad to fit within a display space of certain dimensions.

A region of a web page identified for insertion of an advertisement is known as a “placement.” Synonyms for placement include “zone,” “placement id,” “ad tag,” or “placement tag.”

A “passback” is a notification sent from an ad source to indicate to a requester that a suitable ad is not available at the ad source. A passback is typically comprised of HTML or JAVASCRIPT code. A passback may also be referred to as a “passthru.”

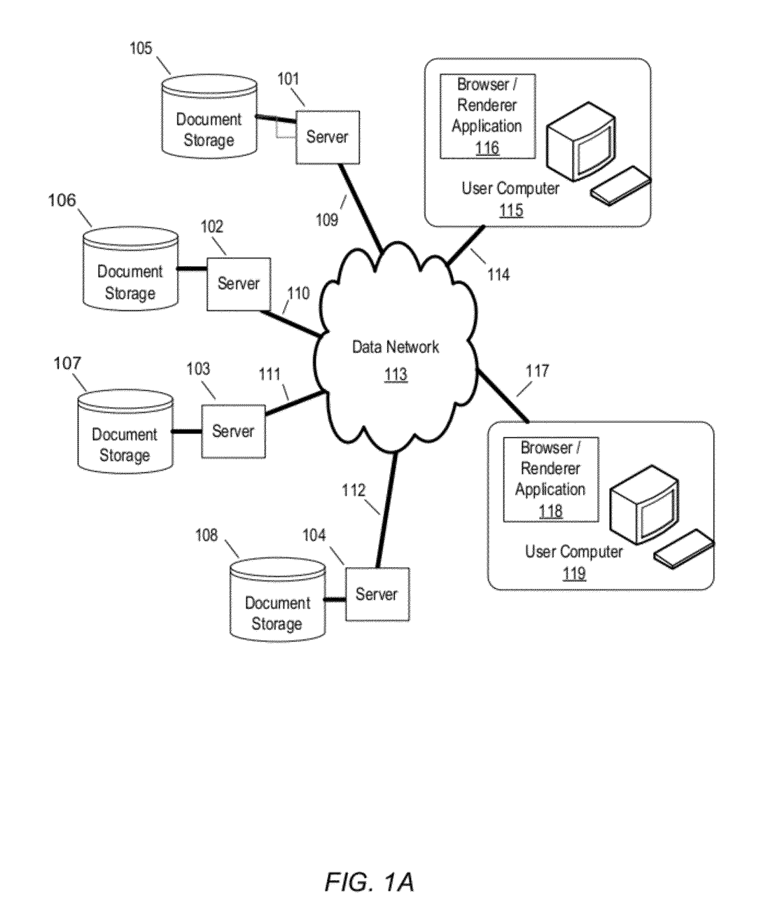

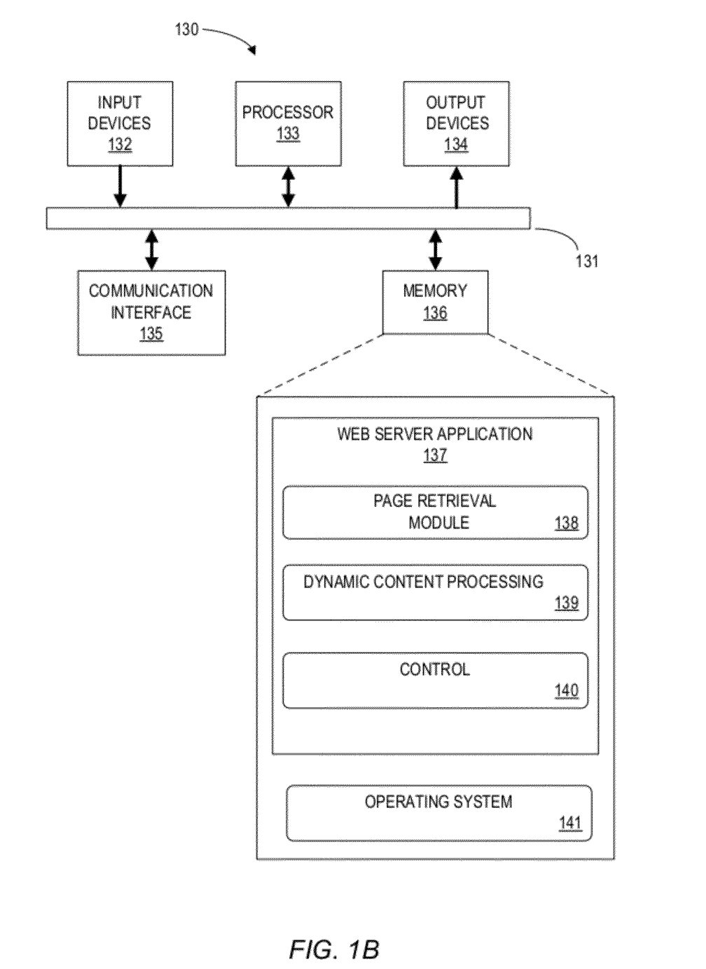

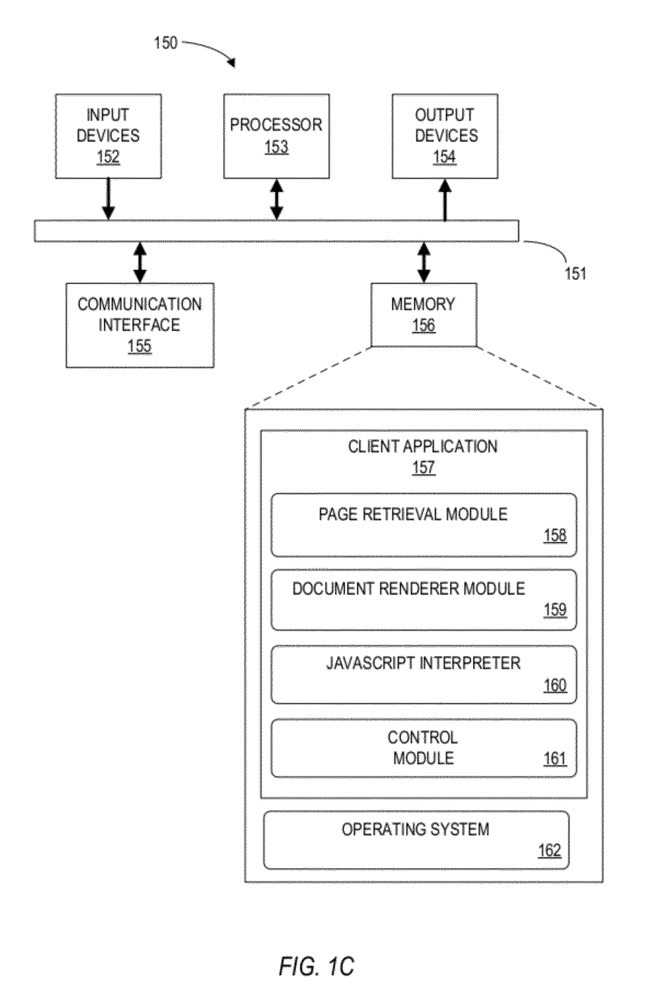

Referring now to the drawings, where like or similar elements are designated with identical reference numerals throughout the several views, FIG. 1A is a schematic depiction of an exemplary environment in which the features and descriptions herein can be practiced in accordance with various illustrative embodiments of the invention. Servers 101, 102, 103, and 104 are content servers configured to respond to requests for content and deliver corresponding content via the associated network connection. Server 101 connects to data network 113 through network connection 109 and provides content stored in document storage 105. Server 102 connects to data network 113 through network connection 110, providing content from document storage 106. Server 103 connects to data network 113 through network connection 111 and provides content from document storage 107. Server 104 connects to data network 113 through network connection 112 and provides content from document storage 108.

It should be appreciated that the servers 101, 102, 103, and 104 are shown as single units for illustration. Each server 101-104 may in practice be multiple units, clusters, or networks that appear to other devices on the network 113 as a single node. Similarly the document storage facilities 105, 106, 107, and 108 can be databases, storage clusters, or multiple storage devices.

In one example, data network 113 is the Internet, and servers 101-104 operate to provide documents to a web. In an exemplary system, the web is the World Wide Web. Thousands of servers connect to the World Wide Web. In one example, servers 101, 102, 103, and 104 are web servers, and the documents provided are HTML, Extensible Hypertext Markup Language (XHTML), and media files. In one example, at least some of the documents provided by servers 101-104 are weblogs or blogs and associated media content.

In FIG. 1A, a user computer 115 is also shown that executes browser application 116 and connects to network 113 via connection 114. Similarly, user computer 119 executes application 118 and connects to data network 113 via connection 117.

It should also be appreciated that although only four servers 101, 102, 103, and 104 are illustrated as connected to data network 113, any number of servers can be connected to data network 113 without departing from the principles of the invention. Data network 113 is illustrated as a cloud with several representative connections 109-112, 114, and 117 to emphasize that many different networks and connection schemes can be used as a basis for various exemplary embodiments of the invention.

FIG. 1B is a functional block diagram of a machine 130 equipped with a web server application 137 in accordance with an illustrative embodiment of the invention. In FIG. 1B, processor 133 communicates over data bus 131 with input devices 132, output devices 134, communication interface 135, and memory 136. Though FIG. 1B shows only a single processor, multiple processors or a multi-core processor may be present in some embodiments. Computer 130 may be any computing device capable of executing web server application 137. For example, computer 130 may be, without limitation, a personal computer, a server, a workstation, a laptop computer, or a notebook computer.

Input devices 132 include, for example, a keyboard, a mouse or other pointing device, or other devices used to input data or commands to computer 130 to control its operation.

In the illustrative embodiment shown in FIG. 1B, communications interface 135 can include one or more instances of a Network Interface Card (NIC) that implements a standard such as IEEE 802.3 (often referred to as “Ethernet”) or IEEE 802.11 (a set of wireless standards). In general, communication interface 135 permits computer 130 to communicate with other computers via one or more networks. In particular, communications interface 135 permits computer 130 to act as a server in a web. In one embodiment, communications interface 135 permits computer 130 to exchange messages with other computers using the Internet. In one embodiment, communications interface 135 permits computer 130 to participate in the World Wide Web.

Memory 136 may include, without limitation, random access memory (RAM), read-only memory (ROM), FLASH memory, magnetic storage (e.g. a disk drive), optical storage, or a combination of these, depending on the particular embodiment.

Memory 136 may also include means for reliable storage of large quantities of data. Such means may include one or more instances of a database, hierarchical or tiered storage systems including a cache, redundant arrays of disks such as RAID systems, flat files, network attached storage (NAS) devices, distributed hash tables, or striped disk arrays.

Processor 133 is configured to execute instructions from memory 136 and manipulate data, also stored and retrieved in memory 136. Instructions are often organized into units known as modules, applications, drivers, files, or code.

In the illustrative embodiment of FIG. 1B, web server application 137 includes several functional modules. Page retrieval module 138 obtains content from one or more storage devices. Dynamic content processor module 139 executes instructions that optionally modify or customize the retrieved page content. Control module 140 coordinates the actions of the functional modules. The division of web server application 137 into the particular functional modules shown in FIG. 1B is merely illustrative. In other embodiments, the functionality of these modules may be subdivided or combined in ways other than that indicated in FIG. 1B, and the names of the various functional modules may also differ in other embodiments.

Computer 130 includes in memory 136 operating system instructions 141, which can be any of a variety of different types, including, without limitation, the MICROSOFT WINDOWS operating system, the LINUX operating system, and the MAC OS operating system, depending on the particular embodiment.

FIG. 1C is a functional block diagram of a machine equipped with a client application in accordance with an illustrative embodiment of the invention. Computer 150 may be any computing device capable of executing client application 157. For example, computer 150 may be, without limitation, a personal computer, a server, a workstation, a laptop computer, or a notebook computer.

In FIG. 1C, processor 153 communicates over data bus 151 with input devices 152, output devices 154, communication interface 155, and memory 156. Though FIG. 1C shows only a single processor, multiple processors or a multi-core processor may be present in some embodiments.

In the illustrative embodiment of FIG. 1C, web client 157 includes several functional modules. Page retrieval module 158 obtains a web page source. Document renderer module 159 processes the source to produce a displayed page. JAVASCRIPT interpreter 160 is an exemplary processor that can be employed in translation of page source to displayed page. Control module 161 coordinates the functional modules with each other and with the operating system and other processes. The division of client application 157 into the particular functional modules shown in FIG. 1C is merely illustrative. In other embodiments, the functionality of these modules may be subdivided or combined in ways other than that indicated in FIG. 1C, and the names of the various functional modules may also differ in other embodiments.

Computer 150 includes in memory 156 operating system instructions 162, which can be any of a variety of different types, including, without limitation, the MICROSOFT WINDOWS operating system, the LINUX operating system, and the MAC OS operating system.

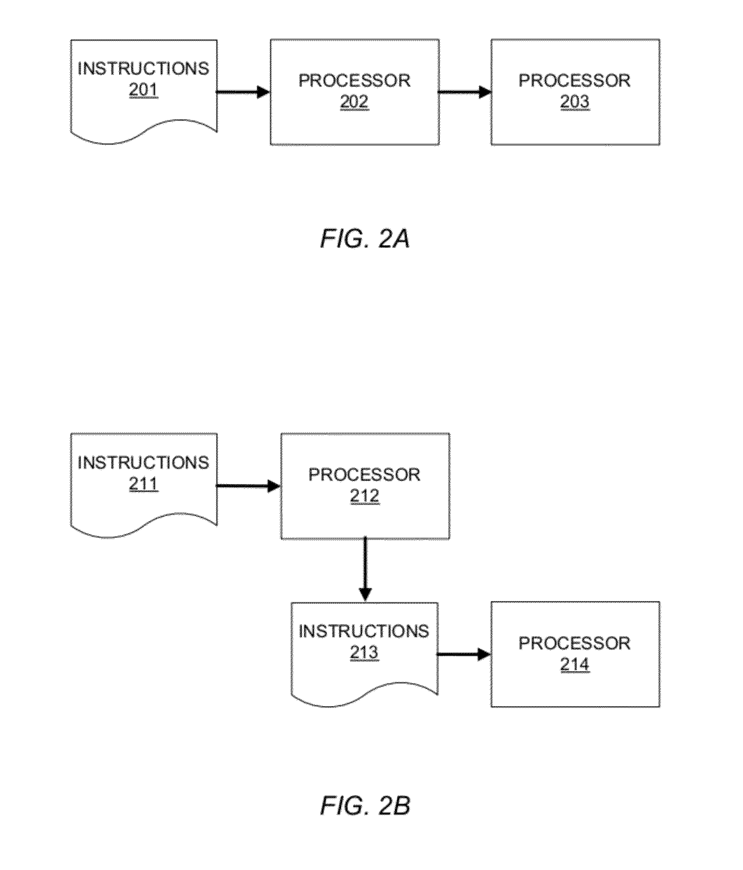

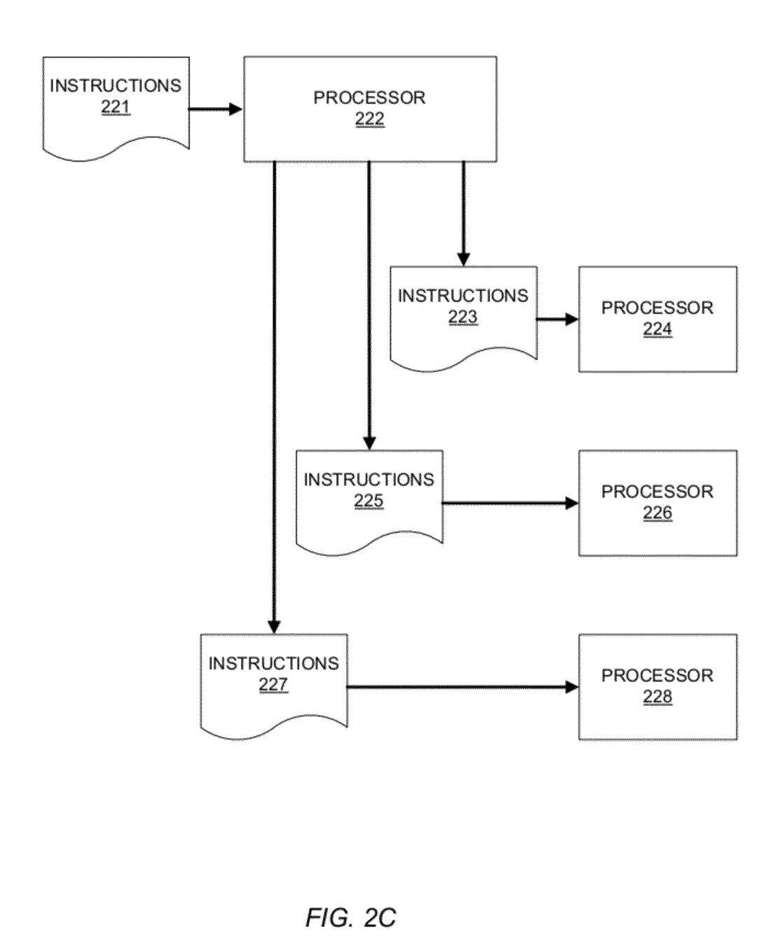

FIGS. 2A, 2B and 2C illustrate the technique of code generation used in various illustrative embodiments of the invention. Refer now to FIG. 2A, in which instructions 201 are used to control processor 202. A processor is a part of a computer, computing device, or other machinery that is directed by instructions. Instructions may comprise a program, code, or functional description of a process or of steps comprising a process. Accordingly, instructions 201 are configured to cause processor 202 to generate further instructions for a second processor 203 that are immediately executed by processor 203 as they are received from processor 202. This technique is familiar to those skilled in the art.

Machines such as processor 202 and 203 can be referred to by many terms, for example machine, interpreter, machine processor, central processing unit, programmable logic controller. Processors 202 and 203 are apparatuses capable of performing operations and guided in operations by instructions. Processors 202 and 203 can also be a virtual machine or application program that can be directed by instructions separately, although a component of another machine.

FIG. 2B illustrates another application of the technique of code generation. Instruction structure 211 controls processor 212, causing processor 212 to generate instructions 213 for control of processor 214. A notable feature of this illustration is that instructions 213 are contained in a structure, allowing storage or transmission across a network. Because instructions 213 can be stored, they can be executed at a different time and location than that of their creation.

It should be appreciated that instructions 211 contain the information necessary to control processor 214 to achieve desired goals and objectives. Instructions 211 also contain the information necessary to encode the desired goals and objectives into a form suitable for control of processor 214. Although instructions 211 are shown as a single block, in practice it is often desirable that instructions 211 be contained in several documents, structures, or files that are used in conjunction with one another to instruct processor 212.

The technique of code generation has a number of advantages. For example, instructions 211 can include logic to determine if certain tasks are better executed by processor 212 or by processor 214, and generate instructions 213 to distribute tasks accordingly. This utilizes the resources of processor 214 and correspondingly reduces resources used by processor 212, increasing the capacity of processor 212. Resources that can be used, for example, include processor cycles, memory, storage, and data network connections.

Refer now to FIG. 2C, which illustrates the technique of code generation used to generate instructions for multiple targets. Instructions 221 cause processor 222 to generate instructions 223, 225, and 227 for processors 224, 226, and 228. Instruction 223 is generated to match processor 224, instruction 225 is tailored for machine 226, and instruction 227 is matched to processor 228.

In this way, instructions 221 cause processor 222 to examine characteristics of each of the target processors 224, 226, and 228 and generate instructions specifically configured for each of them. Exemplary characteristics include the type of machine, the type of client application receiving the instructions, the location of the target processor, and demographic information about the user.

Those skilled in the art will recognize the process illustrated in FIG. 2C as that used by many web servers in generating responses to web client requests. It should be appreciated that one or more of the processors may be configured as components of a single physical computer. For example, processor 226 may correspond to a different application than processor 228, but both may be executing on the same computing hardware. For example, processor 226 corresponds to an instance of the FIREFOX browser application and processor 228 corresponds to an instance of the GOOGLE CHROME browser application. Thus, it is possible for processor 222 to generate instructions matched to a machine type, a location, an application, or to various other parameters. Alternatively, processor 222 can generate instructions that contain decision steps that cause processors 224, 226, and 228 to select appropriate functions when the corresponding instructions are executed.

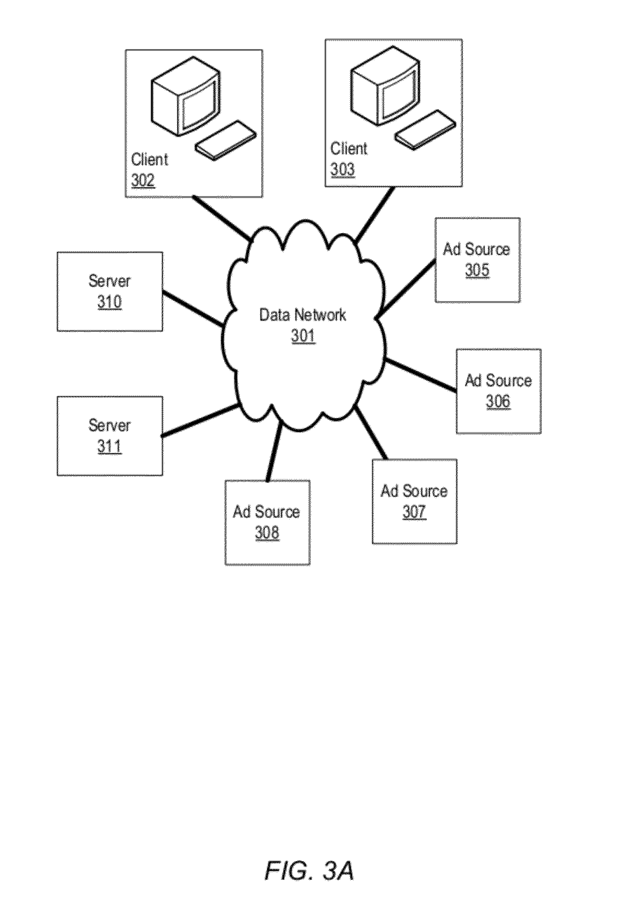

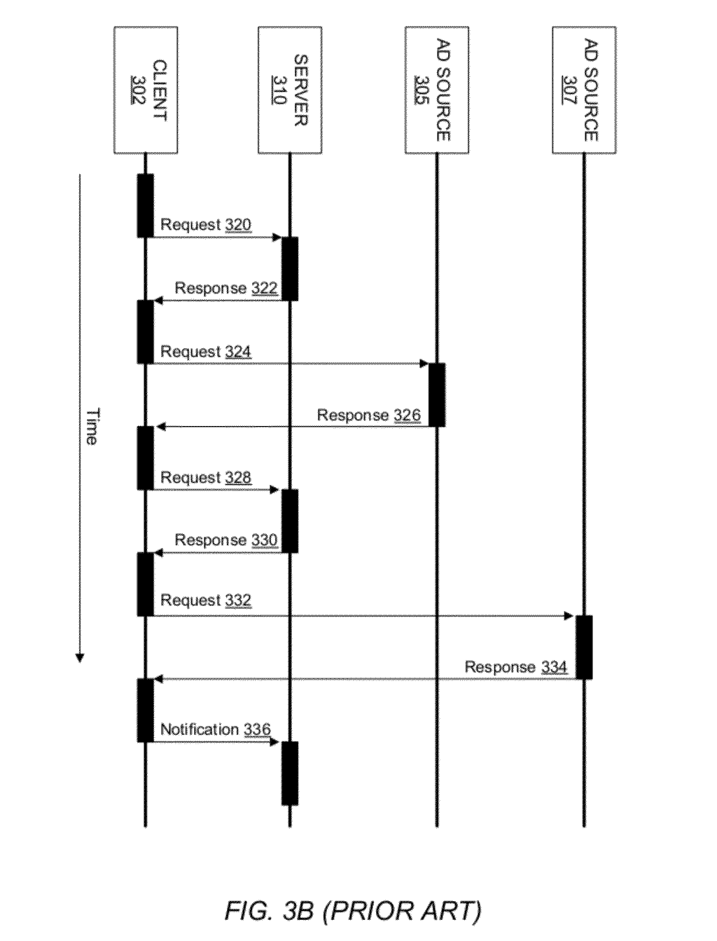

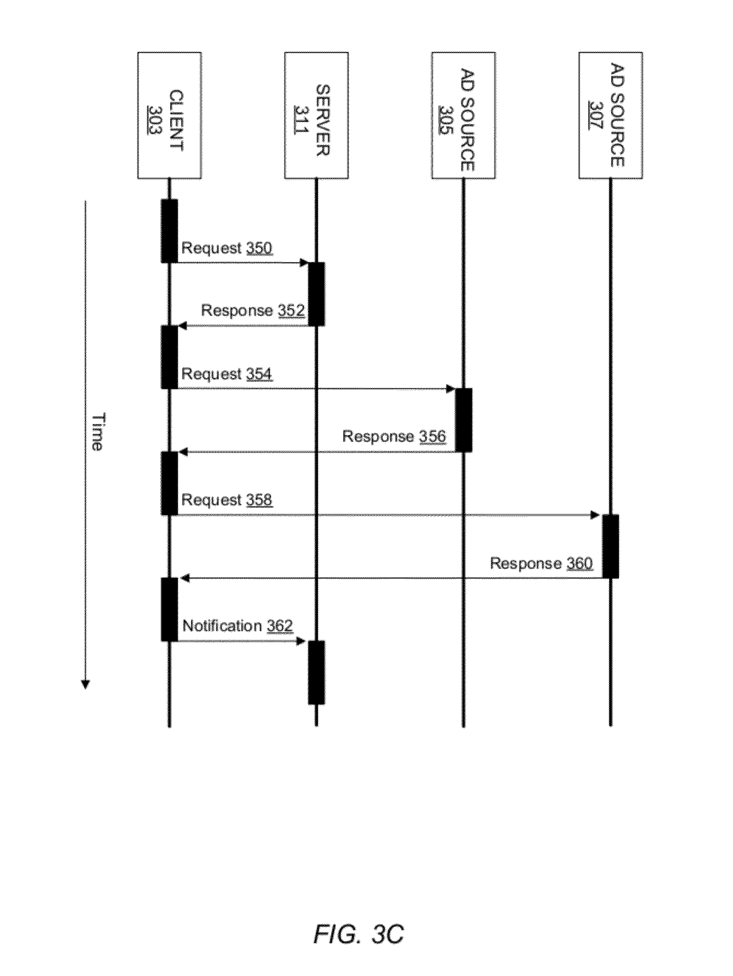

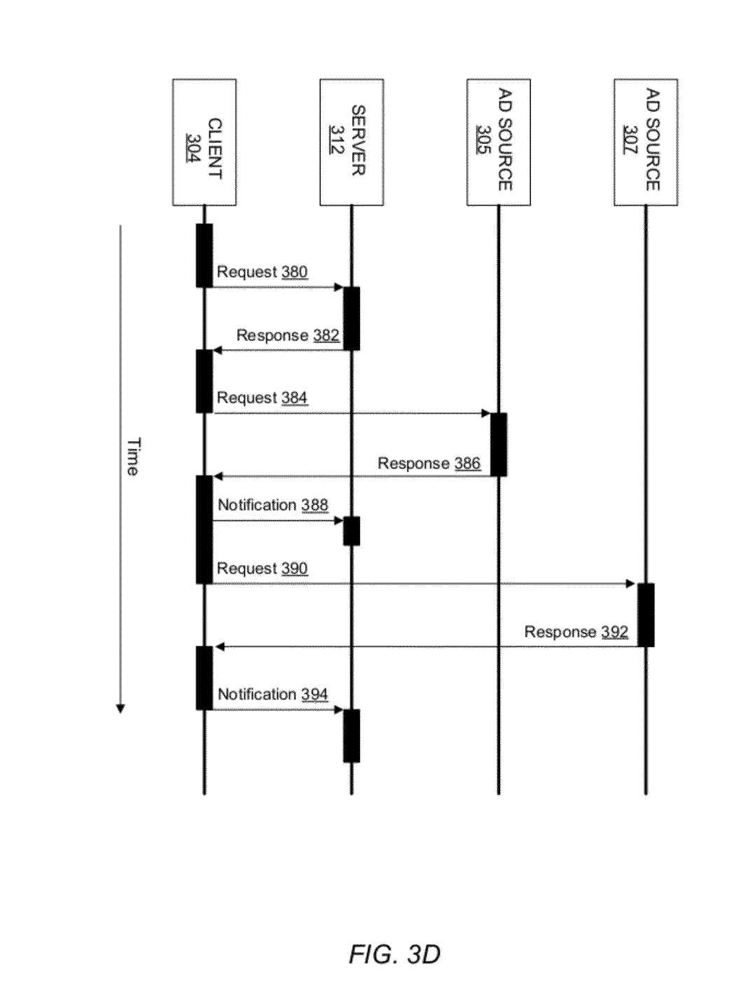

FIG. 3A is a schematic depiction of components and connections which can be used to illustrate various embodiments of the invention. Clients 302 and 303, servers 310 and 311, and ad sources 305-308 are interconnected through data network 301. For example, network 301 can be the Internet, a company intranet, or a local area network.

Refer now to FIG. 3B, which illustrates components from FIG. 3A interacting in accordance with the prior art. Client 302 sends request 320 to server 310. The request may be a request for an advertisement to fill a certain space for display on client 302. Request 320 contains various information about the type of advertisement or banner desired, and may also contain information about the user or viewer who will see the advertisement displayed on client 302.

Server 310 receives request 320 and begins the process of identifying a suitable ad to satisfy the request. Server 310 can be configured with logic and configuration to facilitate the location of a suitable advertisement. For example, the OpenX software package from OpenX.com is one such software package.

Accordingly, server 310 selects a potential ad source from an internal list or ad chain. Server 310 responds to client 302 request 320 with response 322. Response 322 contains a potential ad source 305.

Accordingly, client 302 sends request 324 to ad source 305, requesting a suitable ad. In the illustrated case, source 305 has no suitable ad or declines to offer an ad, sending negative response 326 to client 302. In one embodiment, response 326 is a directive or “ad tag” that refers client 302 back to server 310 so that server 310 may attempt to supply another suitable advertisement from the server-based ad chain.

Client 302 subsequently sends request 328 to server 310, indicating no suitable ad was received from ad source 305 and requesting another potential ad source. Server 310 determines that another ad source is available, or selects the next potential ad source in the server ad chain. Server 310 responds to request 328 with response 330. Response 330 contains another potential ad source 307.

Consequently, client 302 sends request 332 to potential ad source 307. Ad source 307 sends response 334 with a suitable ad locator. Response 334 may contain an ad image, ad text, or an address or URL indicating where the ad can be found and retrieved.

Client 302 displays the advertisement in response 334 and sends success notification 336 to server 310.

FIG. 3C depicts components interacting in accordance with an illustrative embodiment of the invention. Client 303 sends request 350 to server 311. Server 311 is configured in accordance with this illustrative embodiment. However, client 303 and source 305 and 307 need not be reconfigured to interact with server 311. For example request 350, in one embodiment, is essentially identical to request 320 (FIG. 3B). Thus the advantages of the present invention, in various embodiments, can be realized from configuration of server 311 while other components are unmodified. This allows certain embodiments of the invention to interact with unmodified components, providing backwards compatibility.

Accordingly, server 311 receives request 350 and initiates the identification of potential advertisement sources. Using the technique of code generation, server 311 prepares a client instruction structure and sends the structure as response 352. The client instruction structure in response 352, in one embodiment, contains a list of potential advertisements and instructions to client 303 that client 303 will execute to select one of the advertisements from the list.

Executing the client instruction structure received in response 352, client 303 sends request 354 to potential ad source 305, requesting an advertisement. In one embodiment, request 354 is similar to request 324 (FIG. 3B) so source 305 interacts similarly with both a conventional server and with server 311 configured according to the invention. Ad source 305 sends response 356 indicating source 305 has no suitable advertisement. Alternatively, it is possible that ad source 305 fails to respond in an acceptable time period, or fails to respond at all. Consequently, client 302 sends request 358 to ad source 307.

Ad source 307 has a suitable advertisement and indicates this in response 360 to client 303. Client 303 displays the ad indicated in response 360 and sends success notification 362 to server 311. It should be appreciated that any number of sources and ads can be considered before a suitable ad is selected.

Comparing the interaction of conventional server 310 (FIG. 3B) with the interaction of server 311 configured according to the invention, it can be seen that in the illustrated embodiment server 311 spends less time processing and has fewer network interactions than conventional server 310. Server 311, in the illustrated embodiment, uses the resources of client 303, so server 311 uses fewer of its own resources compared to a conventional server. It may also be observed that in FIG. 3C with server 311 configured according to an embodiment of the invention, the desired advertisement is located and displayed with fewer total network transactions than in the conventional system illustrated in FIG. 3B.

It should be noted that the interactions of server 311 with ad source 305 and 307 are sequential in the embodiment illustrated in FIG. 3C and that the first suitable ad located is selected for display. However, in other embodiments client 303 can be instructed by server 311 to make requests to ad sources in a different order or to issue requests to multiple ad sources in parallel.

Client 303 may, in some embodiments, receive several suitable responses and select from among those received. For example, the selection of an ad can be done by evaluating all the responses or by filtering the responses to a subset meeting predetermined criteria. In one embodiment, bids are requested from all sources and the ad is selected by an auction process among all suitable responses.

FIG. 3D depicts components interacting in accordance with another illustrative embodiment of the invention. When interacting with some web browsers, it can be desirable to receive a notification from client 304 to server 312 after each step in the ad chain, illustrated by the embodiment depicted in FIG. 3D.

In FIG. 3D, client 304 sends request 380 to server 312, configured according to an illustrative embodiment of the invention. Accordingly, server 312 receives request 380 and initiates the identification of potential advertisement sources. Server 312 prepares a client instruction structure and sends the structure as response 382.

Executing the client instruction structure received in response 382, client 304 sends request 384 to potential ad source 305, requesting an advertisement. Ad source 305 sends response 386 indicating source 305 has no suitable advertisement. Client 304 proceeds with the ad chain but also sends notification 388 to server 312.

Client 304 sends request 390 to ad source 307, continuing with the ad chaining process. Ad source 307 has a suitable advertisement and indicates this in response 392 to client 304. Client 304 displays the ad indicated in response 392 and sends success notification 394 to server 312.

A problem can arise with the interaction depicted in FIG. 3D in that server 312 receives multiple notifications 388 and 394. In the embodiment of FIG. 3D, each request to an ad source in the ad chain results in a notification to server 312, regardless of the success or failure of the request. Thus server 312 is presented with multiple notifications and must select the one that corresponds to the ad successfully presented.

In one embodiment, this problem is solved by configuring the client instructions to instruct client 304 to generate notifications to server 312 that each include a history of previous notifications sent while executing the present ad chain. Since the final notification corresponds to the ad that was selected, the final notification will contain the longest history. Thus the history in the notification is used to select the notification matching the ad presented. In embodiments including a default item, the notification is also tested to determine if the notification corresponds to the default item or an item from the ad chain.

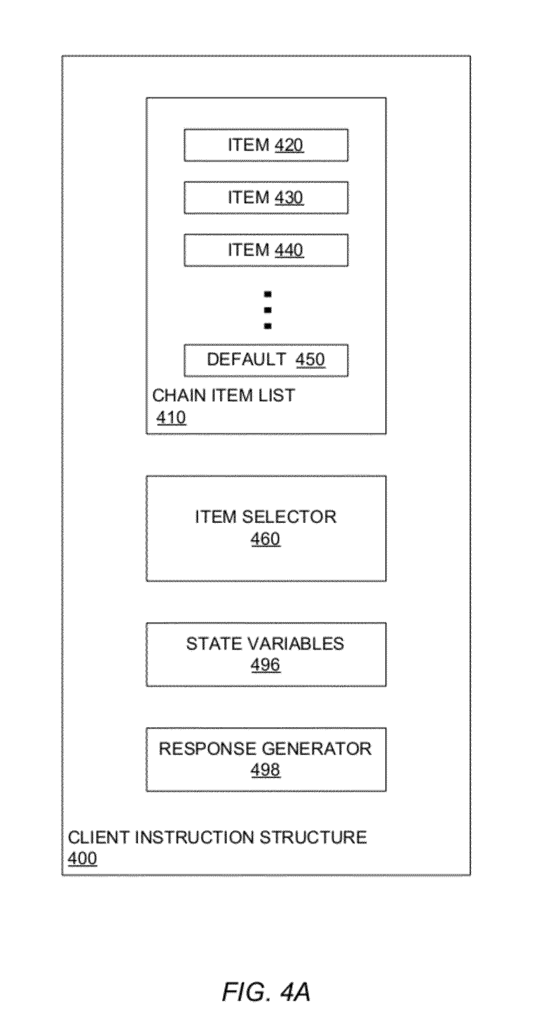

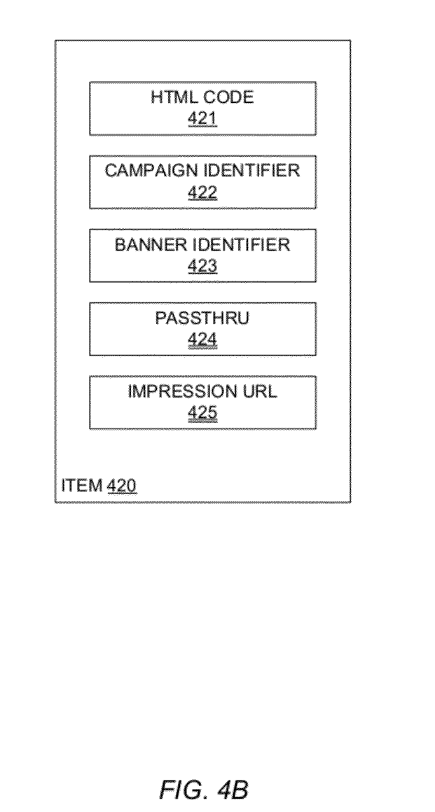

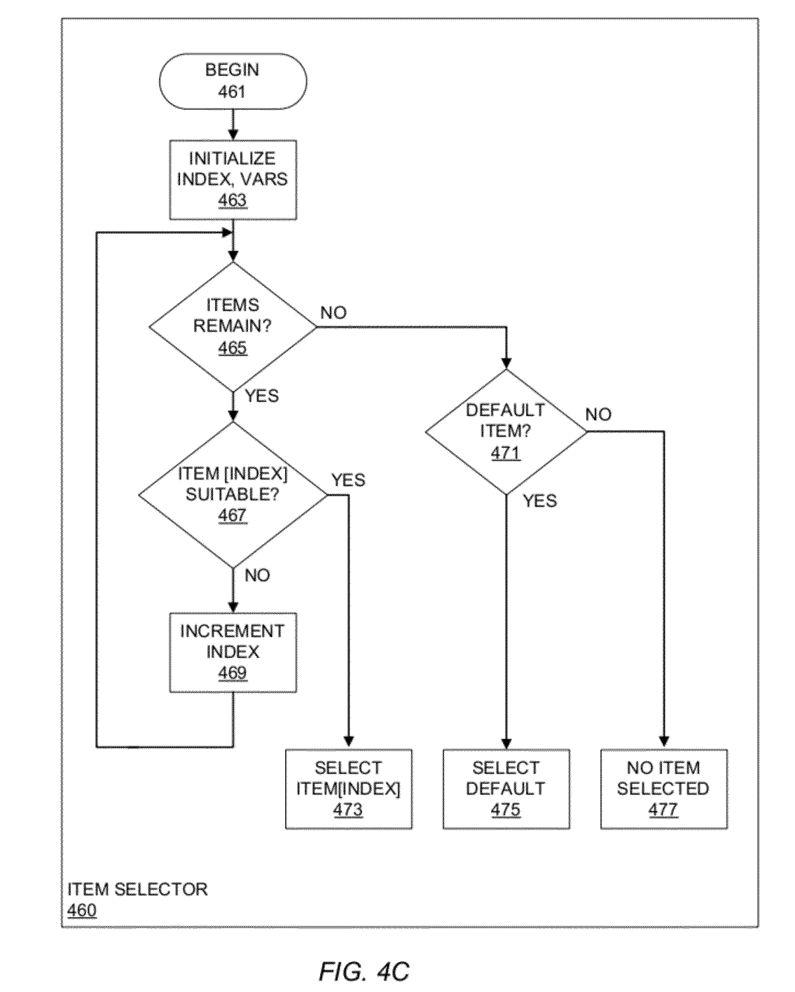

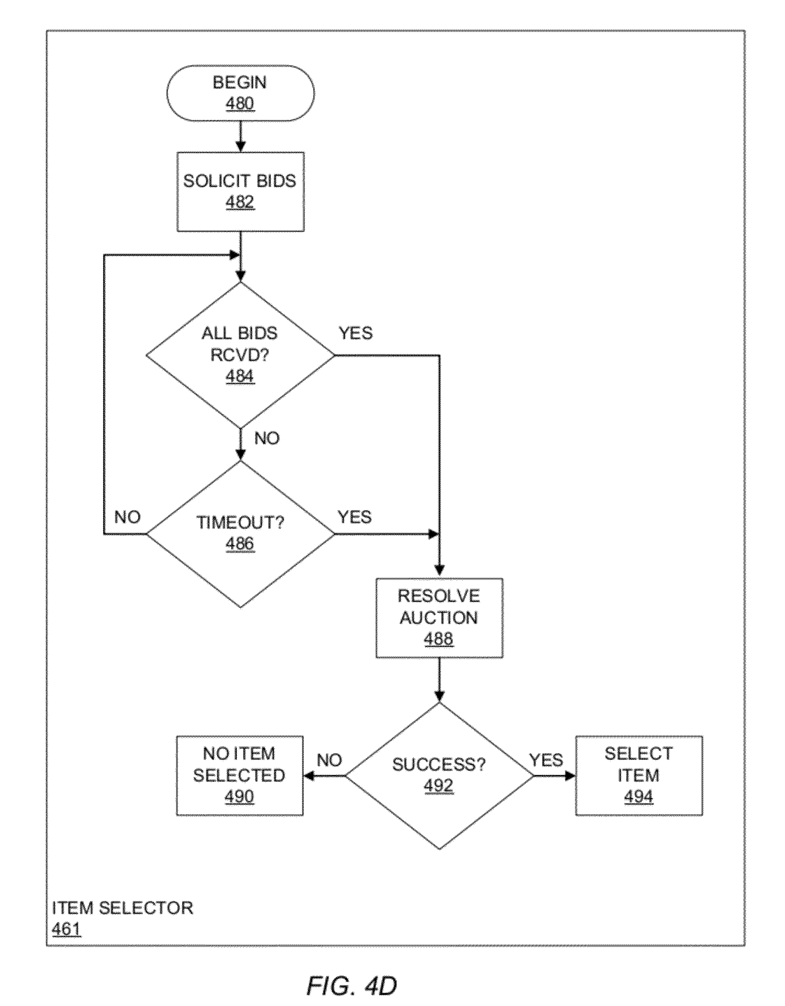

FIG. 4A illustrates a client instruction structure 400 according to an illustrative embodiment of the invention. In the illustrated embodiment, client instruction structure 400 comprises four components. Chain item list 410 is a data structure comprising items, wherein one item may be selected for display. In the embodiment shown in FIG. 4A, list 410 contains item 420, 430, and 440. List 410 may also, optionally, contain one or more default item 450. The number of items in list 410 is not limited to any specific number. List 410, in some embodiments, contains between one and fifty items.

In some embodiments, list 410 is called a chain, ad chain, chain array, browser chain, or item chain. In one embodiment, the chain data items are stored in an array structure. In one embodiment, the chain array is indexed by zone. This provides a separate structure for each zone, such that multiple zones can exist on the same web page without conflicting with ad chains from other zones.

Item selector 460 comprises instructions to the client machine that instruct the machine in a process for selection of one item from item list 410. Selector 460 may also be referred to as a stepping function. Further details of embodiments of item selector 460 are shown in FIGS. 4C and 4D.

Response generator 498 is a set of instructions to the client machine directing the creation of a response to the server indicating success, failure, or status of the ad display process. In some embodiments, a successfully displayed ad is called an “impression,” and response generator 498 is called an impression generator. In some embodiments, response generator includes a timestamp in the response.

State variables 496 maintain the state of the browser chain. In some embodiments, multiple zones exist with a single display page. In one embodiment, state variables are arrays indexed by zone identifier so that multiple zones can exist on the same web page without conflict or confusion among zone states. Some examples of state variables are present index into the ad chain array, query parameters for generating an impression request, and an array of history information. Examples of history array information include campaign identifier, banner identifier, and timestamp.

Refer now to FIG. 4B, which illustrates components of a client instruction structure according to an illustrative embodiment of the invention. The components correspond to one item of the item list. FIG. 4B shows a representative item 420 and components that comprise item 420. HTML code 421 is code used to make the ad request if item 420 is selected. In one embodiment, the code is text in the HyperText Markup Language (HTML). Campaign identifier 422 identifies and distinguishes the campaign to which the ad corresponding to item 420 is associated. Banner identifier 423 identifies the advertisement and distinguishes the advertisement from others. In one embodiment, banner identifier 423 and campaign identifier 422 are integer values.

Passthru 424 is a unique value that is expected as part of a passback. Passthru 424 is a text string in some embodiments. In some embodiments, the passthru is omitted. Impression URL 425 is a Uniform Resource Locator (URL) or other reference that is used when logging the impression for an ad. For example, impression URL 425 is used in some embodiments as the basis of a message to another machine indicating that the ad corresponding to item 420 has been displayed successfully.

A flow chart according to an embodiment of the invention is shown in FIG. 4C. FIG. 4C provides further details of item selector 460. The process begins at 461 and proceeds to 463, where the index and state variables are set to initial values. For example, in one embodiment the item list is stored as an array of items, and the index is varied from one to the number of array items to select one item from the array items as needed. Thus the index is initialized to a value corresponding to the first item in the array. In other embodiments, other data structures are employed to store the items and the index variable is initialized appropriately.

After initialization 463, the process continues at decision 465. Decision 465 determines if all items in the item list have been considered or if at least one potentially suitable item remains. In the case where this is the first pass, decision 465 determines if there are any items in the item list.

At 467 the client determines if the item selected is suitable for display. In one embodiment, the selection test comprises sending a request to the ad source corresponding to the ad and waiting a time period for a suitable response. If an affirmative response is received within the time period, the item is determined to be suitable at 467, the item is selected at 473, and processing is complete. If a negative response is received or a timeout occurs, then processing continues at 469.

In some embodiments, the request to the ad source includes parameters that specify desired ad characteristics, limiting or filtering the response to a request for suitable ads. In some embodiments, an item that is successfully obtained from an ad source is subjected to further filtering or suitability testing at 467 after it is received. For example, in the case of an advertisement, tests can include floor price or a number of times the advertisement has been presented previously.

It should be appreciated that filtering can be performed by the client processor, by the server processor, or by both. When the client machine instruction is generated by the server processor, server instructions determine which items to include in the item list. Thus the server can filter to determine which items are included in the item list. Filtering can also be performed by the client processor, in which case the server includes filtering instructions as part of the generated code in the item selector component of a client instruction.

Decision 467, incrementer 469 and termination test 465 comprise a loop that iterates through all items in the item list until a suitable item is identified and selected at 467, or until all items have been tested and none selected. If all items in the list have been considered and none selected, decision 465 selects the NO path and processing continues at 471.

In some embodiments, one or more default items are included in the client instruction. A default item is selected when all other items have been rejected or determined to be unsuitable. A default item is also selected when no other items are available. At decision 471, it is determined if a default item is included. If a default item is available, the default item is selected at 475, and the process is complete. If no default item is found at 471, then processing terminates at 477 with no item selected. In some embodiments, if the process ends with no item at 477, a message is returned to the server.

It should be appreciated that the process described in the flowchart of FIG. 4C considers the items in a predetermined order and selects the first item that satisfies the suitability test at 467. The order of the items and the order in which they are considered is a function of both the server and client instruction and operations. Therefore it is possible to arrange and consider items in any sequence in various embodiments of the invention.

A flow chart according to another illustrative embodiment of the invention is shown in FIG. 4D. In FIG. 4D, item selector process 461 begins at 480. Each of the items in the item list is considered in parallel to select an item for display. Processing proceeds at 482 where a bid is solicited on behalf of every one of the items in the list. In one embodiment, the client sends a request to the ad source associated with each item in the item list.

The process then waits for either the return of all bids at 484 or passage of a set period of time at 486. In either case, the bids received within the time period are compared at 488. Each bid is scored in one or more categories, and scores are compared to determine an auction winner. In one embodiment, a metric or overall score is assigned to each item based on a bid, and the item with the highest overall bid score is selected. The scores may be numeric, comparative, or qualitative and there are many ways to assign or compare scores, all in accordance with various embodiments. In one embodiment, bids are monetary and the winner is decided by selecting the highest bid amount. In some embodiments, the process is a participant in an operation referred to as “Real Time Bidding” or RTB.

It should be appreciated that the embodiments illustrated in FIG. 4C and FIG. 4D are only two possible processes for selection of an item from the items in the client instruction. Many other processes are possible. For example, according to various embodiments, the selection process may involve filtering, absolute and relative scoring, sorting, ranking, auction, and bidding. In some embodiments, the first item that meets a set of criteria is selected. In other embodiments several items are evaluated, compared, and the best item is selected. The several items can include all of the items in the item list or a subset.

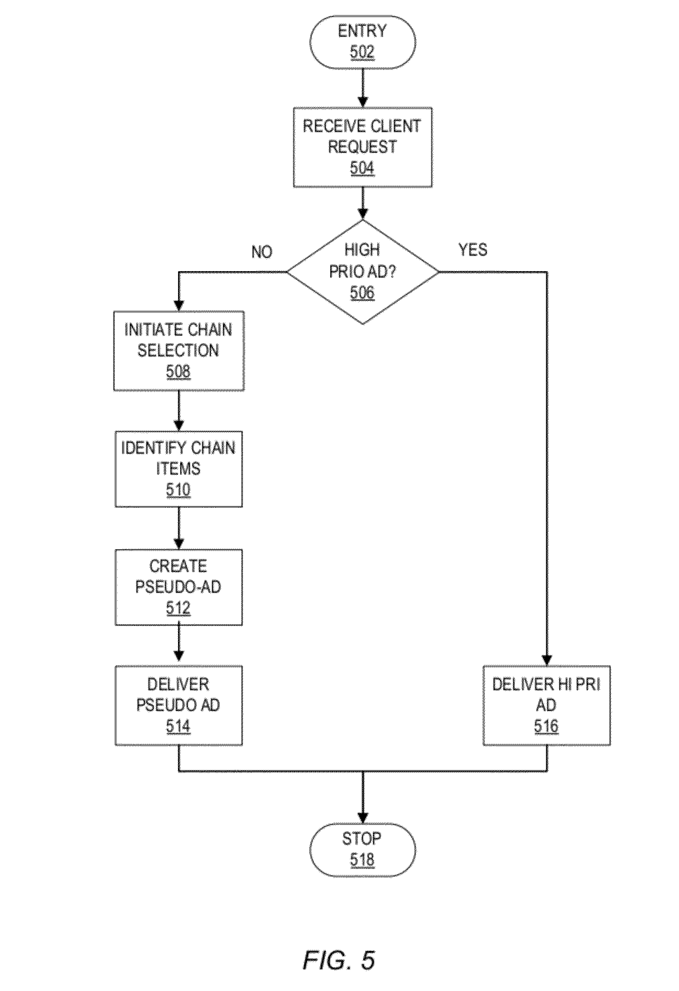

FIG. 5 is a flow chart illustrating a process for generating client instructions in accordance with an embodiment of the invention. The process depicted in FIG. 5 takes place on a server machine and begins with entry 502. When a client request is received, processing continues at 504. In one embodiment, the client request is also known as an ad request. The ad request can contain a variety of information useful to the server in identifying a list of suitable advertisements. For example, the ad request may include some or all of the following: an identifier of the user, a unique username, non-personal information about a user, user demographic information, and user location information. The ad request may also include the size available for the ad presentation. For example, an ad zone size can be expressed in pixels, inches, or other units. The ad request may also include information about other content on the page that will be displayed with the advertisement, information about the publisher of the other content, or preferences of the publisher in regard to advertising content.

Continuing with FIG. 5, at 506 a decision is made to determine if any high-priority ad can satisfy the request. High priority ads are also known by other terms such as exclusive, contract, or companion advertisement. The process will often select a high priority ad if one is available, delivering the high priority ad at 516. The process terminates at 518. However, there are circumstances where decision 506 will not select a high priority ad even if available. Often, no high-priority ad is available.

If decision 506 does not select a high priority ad, chain selection is initiated at 508. At 510, advertising items are selected for inclusion in the chain item list. The selection process considers what is known about the client, the user, and the parameters received in the ad request in conjunction with advertisements and campaigns available. Other filters may also be applied based on the advertiser's desires. For example, an advertiser may desire to prevent ads from being displayed to users in a certain geographic region, or to audiences of a certain age group.

Once the items in the chain are identified at 506, the process continues, adding the other components of the client instruction. A client instruction is also sometimes called a “pseudo-ad,” since it will be returned to the client in much the same way a single ad would be returned. For description of a client instruction according an embodiment of the invention, refer to FIG. 4A and the corresponding descriptions. The pseudo-ad is delivered to the client at 514, and the process terminates at 518.

The server, optionally, is configured to receive an impression tag notification from the client that received the pseudo-ad. The impression tag indicates the status of the ad display, for example that the ad was displayed successfully, or that the ad was not displayed. Since a pseudo-ad can contain more than one ad item, the impression tag also serves as feedback information indicating which of the ad items was selected. Information from the impression tag can be used to determine ad chain items in the future. For example, it may be desirable to limit the number or frequency of impressions to a user or type of user by counting the number of times an ad has been previously presented.

The process described in FIG. 5 is a result of a machine directed by instructions. In one embodiment, the instructions are from more than one source. For example, the processing instructions include computer program code, templates, and one or more configuration files or state variables. In one embodiment, processing instructions include functions written in the PHP programming language. In some embodiments, the response is generated by completing partial responses or templates that are preconfigured and stored.

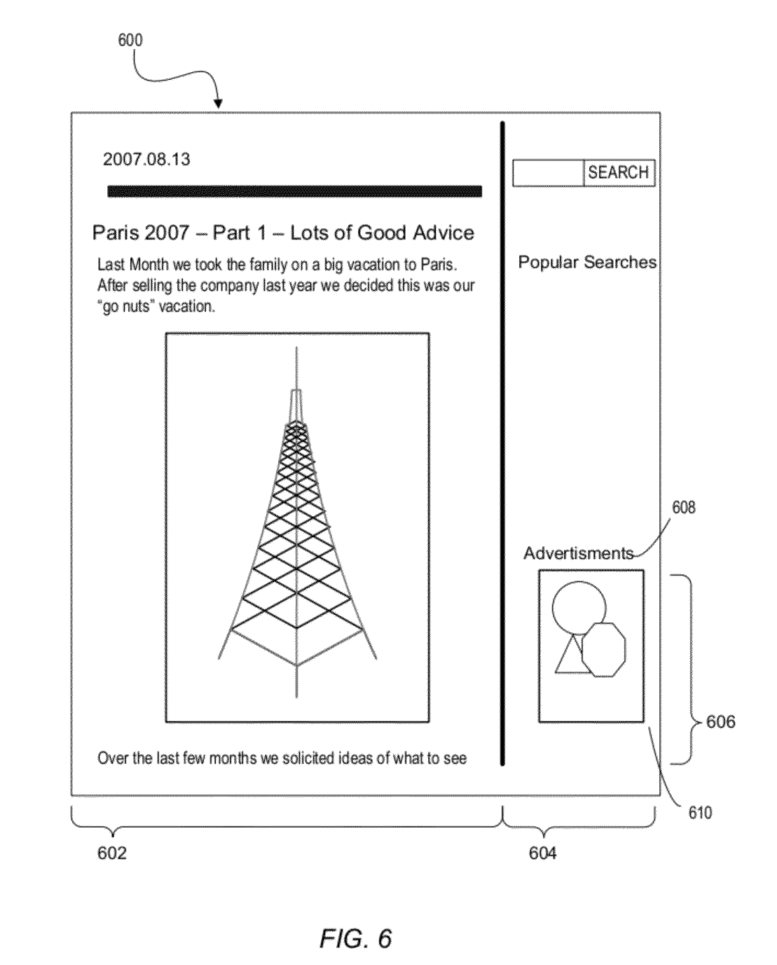

FIG. 6 schematically depicts a displayed page corresponding to an illustrative embodiment of the invention. Display page 600 is a window displayed on a computer or video display. Display page 600 is a schematic depiction of a display of a weblog. A weblog, or blog, is a publication systems allowing authors to post content including text, images, and other media on topics of interest. Display 600, in the illustrated embodiment, is divided into two primary regions. Region 602 is the blog author content area. Region 604 is an auxiliary content area where items can be displayed with the blog content 602. For example, blogs are often displayed with one or more advertisements. Accordingly, a region 606 of auxiliary area 604 is allocated for display of advertising. Optional section label 608 identifies the advertising region of the page but is often omitted. The FIG. 610 is an advertising image that fits within the region defined by horizontal delimiter 604 and vertical delimiter 606.

In conclusion, the present invention provides, among other things, a system and method for selecting content for display in an electronic document. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the claims.

What is claimed is:

1. A computer-implemented method for selecting content for display in an electronic document, the computer-implemented method comprising:
receiving, at a server from a client computer over a network, a request for a content item;
generating, at the server, a client instruction structure that includes a list of potential content items and a set of client instructions to be carried out by a browser application of the client computer to select, from the list of potential content items, a particular content item for display in the electronic document based on predetermined suitability criteria specified by the server in the set of client instructions; and
transmitting the client instruction structure from the server to the client computer over the network.

2. The computer-implemented method of claim 1, wherein the electronic document is a web page.

3. The computer-implemented method of claim 1, wherein the list of potential content items is a list of potential on-line advertisements.

4. The computer-implemented method of claim 1, wherein the set of client instructions generated at the server is configured to cause the browser application to:
evaluate the potential content items in the list of potential content items sequentially in a predetermined order; and
select, as the particular content item for display in the electronic document, the first potential content item in the list of potential content items that satisfies the predetermined suitability criteria.

5. The computer-implemented method of claim 1, wherein the set of client instructions generated at the server is configured to cause the browser application to evaluate the potential content items in the list of potential content items in parallel prior to selecting the particular content item for display in the electronic document.

6. The computer-implemented method of claim 1, wherein the set of client instructions generated at the server is configured to cause the browser application to select the particular content item from among a plurality of potential content items that satisfy the predetermined suitability criteria.

7. The computer-implemented method of claim 1, wherein the list of potential content items includes a default content item, and wherein the set of client instructions generated at the server is configured to cause the browser application to select, as the particular content item, the default content item when the other potential content items in the list of potential content items fail to satisfy the predetermined suitability criteria or are unavailable.

8. The computer-implemented method of claim 1, wherein the set of client instructions generated at the server is configured to cause the browser application to select the particular content item via an auction process.

9. The computer-implemented method of claim 8, wherein the auction process includes comparing solicited bids associated with the respective potential content items to determine an auction winner, the particular content item corresponding to the auction winner.

10. The computer-implemented method of claim 1, wherein parameters included in the request for a content item are taken into account in generating the client instruction structure.

11. The computer-implemented method of claim 10, wherein the parameters include at least one of information about a user associated with the client computer and information about the client computer.

12. The computer-implemented method of claim 10, wherein the parameters include ad selection criteria from an advertiser.

13. The computer-implemented method of claim 1, wherein the list of potential content items is indexed by zone, each zone corresponding to a particular region of the electronic document.

14. The computer-implemented method of claim 1, wherein the set of client instructions generated at the server is configured to cause the browser application to select a high-priority content item from the list of potential content items when a high-priority content item is available.

15. The computer-implemented method of claim 1, wherein the set of client instructions includes at least one of scripting-language code and Hypertext-Markup-Language (HTML) code.

16. A system for selecting content for display in an electronic document, the system comprising:
at least one processor; and
a memory connected with the at least one processor, the memory containing a plurality of program instructions configured to cause the at least one processor to:
receive, over a network, a request for a content item from a client computer;
generate a client instruction structure that includes a list of potential content items and a set of client instructions to be carried out by a browser application of the client computer to select, from the list of potential content items, a particular content item for display in the electronic document based on predetermined suitability criteria specified in the set of client instructions; and
transmit the client instruction structure to the client computer over the network.

17. The system of claim 16, wherein the set of client instructions to be carried out by the browser application is configured to cause the browser application to:
evaluate the potential content items in the list of potential content items sequentially in a predetermined order; and
select, as the particular content item for display in the electronic document, the first potential content item in the list of potential content items that satisfies the predetermined suitability criteria.

18. The system of claim 16, wherein the set of client instructions to be carried out by the browser application is configured to cause the browser application to evaluate the potential content items in the list of potential content items in parallel prior to selecting the particular content item for display in the electronic document.

19. The system of claim 16, wherein the set of client instructions to be carried out by the browser application is configured to cause the browser application to select the particular content item from among a plurality of potential content items that satisfy the predetermined suitability criteria.

20. The system of claim 16, wherein the set of client instructions to be carried out by the browser application is configured to cause the browser application to select the particular content item via an auction process.

21. The system of claim 20, wherein the set of client instructions to be carried out by the browser application is configured to cause the browser application to compare solicited bids associated with the respective potential content items to determine an auction winner, the particular content item corresponding to the auction winner.

22. A non-transient computer-readable storage medium containing a plurality of program instructions executable by at least one processor to select content for display in an electronic document, the plurality of program instructions comprising:
a first code segment configured to cause the at least one processor to receive, over a network, a request for a content item;
a second code segment configured to cause the at least one processor to generate a client instruction structure that includes a list of potential content items and a set of client instructions to be carried out by a browser application of the client computer to select, from the list of potential content items, a particular content item for display in the electronic document based on predetermined suitability criteria included in the set of client instructions; and
a third code segment configured to cause the at least one processor to transmit the client instruction structure to the client computer over the network.

23. A computer-implemented method for selecting content for display in an electronic document, the computer-implemented method comprising:
transmitting, to a server over a network, a request for a content item to occupy a particular region of the electronic document;
receiving, from the server over the network in response to the request, a client instruction structure that includes a list of potential content items and a set of client instructions, the set of client instructions including predetermined suitability criteria specified by the server for selecting a particular content item from the list of potential content items;
carrying out the set of client instructions in a browser application to select, from the list of potential content items, the particular content item; and
displaying the particular content item in the particular region of the electronic document.

24. The computer-implemented method of claim 23, wherein the electronic document is a web page.

25. The computer-implemented method of claim 23, wherein the list of potential content items is a list of potential on-line advertisements.

26. The computer-implemented method of claim 25, wherein carrying out the set of client instructions in a browser application to select, from the list of potential content items, a particular content item for display in the particular region of the electronic document includes:
transmitting, to an ad source associated with a particular potential on-line advertisement in the list, a request for the particular potential on-line advertisement; and
receiving from the ad source information enabling the particular potential on-line advertisement to be selected as the particular content item for display in the particular region of the electronic document.

27. The computer-implemented method of claim 26, further comprising:
transmitting to the server over the network a notification indicating whether the request for the particular potential on-line advertisement was successful.

28. The computer-implemented method of claim 23, wherein the set of client instructions received from the server is configured to cause the browser application to:
evaluate the potential content items in the list of potential content items sequentially in a predetermined order; and
select, as the particular content item for display in the particular region of the electronic document, the first potential content item in the list of potential content items that satisfies the predetermined suitability criteria.

29. The computer-implemented method of claim 23, wherein the set of client instructions received from the server is configured to cause the browser application to evaluate the potential content items in the list of potential content items in parallel prior to selecting the particular content item for display in the electronic document.

30. The computer-implemented method of claim 23, wherein the set of client instructions received from the server is configured to cause the browser application to select the particular content item from among a plurality of potential content items that satisfy the predetermined suitability criteria.

31. The computer-implemented method of claim 23, wherein the list of potential content items includes a default content item, and wherein the set of client instructions received from the server is configured to cause the browser application to select, as the particular content item, the default content item when the other potential content items in the list of potential content items fail to satisfy the predetermined suitability criteria or are unavailable.

32. The computer-implemented method of claim 23, wherein the set of client instructions received from the server is configured to cause the browser application to select the particular content item via an auction process.

33. The computer-implemented method of claim 32, wherein the auction process includes comparing solicited bids associated with the respective potential content items to determine an auction winner, the particular content item corresponding to the auction winner.

34. The computer-implemented method of claim 23, wherein the list of potential content items is indexed by zone, each zone corresponding to a particular region of the electronic document.

35. The computer-implemented method of claim 23, wherein the set of client instructions received from the server is configured to cause the browser application to select a high-priority content item from the list of potential content items when a high-priority content item is available.

36. The computer-implemented method of claim 23, wherein the set of client instructions received from the server includes at least one of scripting-language code and Hypertext-Markup-Language (HTML) code.

37. The computer-implemented method of claim 23, wherein the set of client instructions received from the server includes filtering instructions for selecting the particular content item for display in the particular region of the electronic document based on the predetermined suitability criteria.

38. A system for selecting content for display in an electronic document, the system comprising:
at least one processor; and
a memory connected with the at least one processor, the memory containing a plurality of program instructions configured to cause the at least one processor to:
transmit, to a server over a network, a request for a content item to occupy a particular region of the electronic document;
receive, from the server over the network in response to the request, a client instruction structure that includes a list of potential content items and a set of client instructions, the set of client instructions including predetermined suitability criteria specified by the server for selecting a particular content item from the list of potential content items;
carry out the set of client instructions in a browser application to select, from the list of potential content items, the particular content item; and
display the particular content item in the particular region of the electronic document.

39. The system of claim 38, wherein the set of client instructions received from the server is configured to cause the browser application to:
evaluate the potential content items in the list of potential content items sequentially in a predetermined order; and
select, as the particular content item for display in the particular region of the electronic document, the first potential content item in the list of potential content items that satisfies the predetermined suitability criteria.

40. The system of claim 38, wherein the set of client instructions received from the server is configured to cause the browser application to evaluate the potential content items in the list of potential content items in parallel prior to selecting the particular content item for display in the electronic document.

41. The system of claim 38, wherein the set of client instructions received from the server is configured to cause the browser application to select the particular content item from among a plurality of potential content items that satisfy the predetermined suitability criteria.

42. The system of claim 38, wherein the set of client instructions received from the server is configured to cause the browser application to select the particular content item via an auction process.

43. The system of claim 42, wherein the auction process includes comparing solicited bids associated with the respective potential content items to determine an auction winner, the particular content item corresponding to the auction winner.

44. A non-transient computer-readable storage medium containing a plurality of program instructions executable by at least one processor to select content for display in an electronic document, the plurality of program instructions comprising:
a first code segment configured to transmit, to a server over a network, a request for a content item to occupy a particular region of the electronic document;
a second code segment configured to receive, from the server over the network in response to the request, a client instruction structure that includes a list of potential content items and a set of client instructions, the set of client instructions including predetermined suitability criteria specified by the server for selecting a particular content item from the list of potential content items;
a third code segment configured to carry out the set of client instructions in a browser application to select, from the list of potential content items, the particular content item; and
a fourth code segment configured to display the particular content item in the particular region of the electronic document.
